(19) United States
(12) Patent Application Publication
(10) Pub. No.: US 2007/0290878 A1
(43) Pub. Date: Dec. 20, 2007

(54) SYSTEM AND METHOD FOR INTERACTING WITH AUTOMOBILE RACE AND ADVERTISING CONTENT

(75) Inventor: Frank S. Maggio, St. Petersburg, FL (US)

Correspondence Address: KING & SPALDING LLP, 1180 PEACHTREE STREET, ATLANTA, GA, 30309-3521, US

(73) Assignee: Media IP Holdings, LLC, St. Petersburg, FL (US)

(21) Appl. No.: 11/697,577

(22) Filed: Apr. 6, 2007

Related U.S. Application Data
(60) Provisional application No. 60/790,329, filed on Apr. 7, 2006.

(51) Int. Cl. G05B 19/02; G06F 3/02

(52) U.S. Cl. 340/825.24; 345/169; 725/23

(57) ABSTRACT

Methods and systems for interacting with automobile race and advertising content include providing race viewers with data related to races occurring in real-time. The data provided can include audio communications between drivers and their teams, statistics related to the race, and historical data related to drivers participating in the race. Race viewers can use a remote control with the form factor and functionality of a standard remote control to receive such data and otherwise interact with the automobile race and advertising content. Race viewers also can utilize the remote control to interact with automobile race content and advertising content broadcast during the race by answering questions related to the content. Race viewers can earn rewards by paying close attention to the broadcasts and advertisements and answering questions correctly. Thus, both the viewing experience of automobile race viewers and the value of advertising shown during such broadcasts can be enhanced.

### RELATED PATENT APPLICATION

This patent application claims priority under 35 U.S.C. §119 to U.S. Provisional Patent Application No. 60/790,329, entitled “System and Method for Interacting with Automobile Race and Advertising Content,” filed Apr. 7, 2006. The complete disclosure of the above-identified priority application is hereby fully incorporated herein by reference.

### TECHNICAL FIELD

The invention relates to systems and methods for interacting with automobile race and advertising content. In particular, the invention relates to systems and methods for providing automobile race viewers with data relating to automobile races and for allowing the automobile race viewers to interact with content relating to automobile races via a handheld remote control unit.

### BACKGROUND

Automobile racing has become one of the most popular sporting events in the United States and the world. Millions of racing fans watch television broadcasts of automobile races from several different racing leagues, such as the National Association for Stock Car Auto Racing (NASCAR), Formula 1, and the Indy Racing League. In fact, NASCAR television broadcasts generally attract higher ratings than broadcasts of any sporting league in the United States other than the National Football League, thereby creating large audiences for potential advertisers.

Whether watching an automobile race live or on television, some racing fans may enhance the viewing experience by listening to the drivers communicate with their teams or “pit crews.” Each driver and team communicate throughout the race to discuss strategy and assistance needed by the driver, so automobile fans are able to learn more about the race by listening to these communications. Those fans that attend the racing event live often can purchase or lease a headset that can be tuned to different frequencies and broadcast the communications of one or more drivers and teams. Listening to only one driver at any given time can be boring for the fans, as there may be large periods of time when communications are not occurring. Conversely, listening to multiple drivers' communications on these headsets could be confusing, as it can be difficult for the fans to determine which drivers' communications are being broadcast at any given time. In addition to the fans that listen to the communications via headsets while watching the races live, fans that watch the racing event on television often can listen to the same communications on their personal computers, as the audio can be streamed over the Internet.

However, viewers of a televised automobile race may not want to move back and forth between their computer and their television. Even if a viewer's television and computer are in the same room, the viewer may find it unnatural and cumbersome to configure the computer to be able to stream audio content while still paying attention to the automobile race. Viewers may therefore neglect substantial portions of the automobile race, or the commercial messages aired during the race, to be able to listen to the drivers' audio communications. Viewers also may abandon the effort altogether if it proves too cumbersome. These difficulties therefore can lead to a decrease in the value of the advertising market during racing broadcasts.

Therefore, a need exists in the art for a method and system for providing automobile race viewers with data relating to automobile races, such as the audio communications of drivers, in a more efficient, natural, and easier form than through currently available methods. Specifically, a need exists in the art for providing automobile race viewers with audio communications of drivers and other data in a way that enhances their viewing experience while also enhancing the value of advertising time during the racing broadcast.

### SUMMARY

The invention relates to methods and systems for allowing automobile race viewers to interact with automobile racing broadcasts and advertising shown therein in an efficient, natural, and easy manner.

In one aspect, a race viewer can utilize a remote control to receive audio communications of drivers participating in an automobile race and other data related to the race. The race viewer can select the type of data that he or she wishes to receive while watching the race. The types of data that the user can select can include the audio communications of one or more drivers' teams, statistics related to the race, and historical data related to drivers participating in the race. The remote control can include, in addition to features associated with standard remote controls, a speaker for presenting audio communications, a display for presenting data visually, and various keypads through which the race viewer can operate the remote control and select the data the race viewer desires.

In another aspect, the remote control utilized by the race viewer can be designed in a compact, handheld form factor resembling a standard remote control. This form factor can include the balance, weight, design, and dimensions of a conventional multi-function or universal remote control, and can allow for one-handed use by the race viewer. This remote control can provide the functionality of a traditional remote control in addition to the features related to automobile racing data described herein.

The form factor of the remote control can provide a significant advantage over utilizing a personal computer to receive data related to automobile races. Unlike personal computers, PDAs, cellular phones, and other devices capable of accessing the Internet to receive data, this device can be marketed as a remote control, because its appearance can cause consumers to recognize that it is a multi-function remote control. The appearance and functionality also can lead retailers to sell the remote control in proximity to where they sell standard remote controls. A consumer encountering the remote control then, upon further inspection, can recognize the additional feature of interaction with broadcast content. Furthermore, if one member of the race viewer's residence is hesitant about purchasing a device to interact with advertisements, automobile races, or other broadcast content, the appearance and functionality can persuade that member to purchase the remote control, because it can replace multiple remote controls already used in the residence and can provide the additional interactive functionality.

Additionally, because the remote control both resembles and functions as a standard remote control, race viewers will be able to utilize this device naturally and easily while watching a racing broadcast. In general, remote controls are differentiated in retail outlets and in the mind of consumers, and have earned a distinctive position as a device within the television viewing venue. Because people are either right handed or left handed, one and only one device can earn the right to be the “palm habitant” while experiencing television, as the mouse has done in the computer environment. Also, there is an entire sub-industry of replacement remote controls in which this remote control would qualify for consideration. A laptop, PDA, or cellular phone however would not qualify as such a replacement because of their form factor. There is a science to migrating applications to a remote control form factor so as to win the sole right to control the palm of the television viewer; the form factor of this device takes this science into account.

In still another aspect, a race viewer can utilize the remote control to interact with broadcast content presented on a broadcast receiver, such as a racing broadcast shown on television. A race viewer can be presented with interactive content, such as questions about advertisements or other broadcast content shown over a broadcast network. Advertisements and/or questions presented to the race viewer over a variety of media. For instance, they can be shown on the remote control itself or on the broadcast receiver. The race viewer then can respond to questions about the advertisements or broadcast content by utilizing the remote control, or by utilizing a separate information processing unit, a telephone, or any other method of data communication.

Race viewers who interact with broadcast content can receive a reward for correctly answering questions. Types of rewards include a reduction in the possible fees charged for utilizing the remote control, coupons, free samples, prizes, cash, discounts, or other suitable rewards. The possibility of earning rewards can encourage race viewers to interact with broadcasts such as automobile races, and therefore they may pay closer attention to both to the broadcasts themselves and to the advertisement shown during the broadcast. Querying race viewers about commercials and automobile races therefore can promote audience attentiveness to the broadcast, facilitate product purchases, and enhance awareness of brands and the automobile race itself.

Therefore, because of the form factor and functionality of the remote control, as well as the ability to interact with automobile racing broadcasts, the invention can enhance both the viewing experience of automobile race viewers and the value of advertising shown during such broadcasts.

Additionally, in yet another aspect, a race viewer can receive audio communications from multiple drivers participating in a race. The race viewer can receive these communications simultaneously, and also can receive an indication as to which drivers' communications are being presented at any given time.

These and other aspects, objects, and features of the invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a system for interacting with multiple race viewers according to an exemplary embodiment.

FIG. 2 is a block diagram depicting a system interacting with each race viewer according to an exemplary embodiment.

FIG. 3 is a block diagram depicting the components of a remote control according to an exemplary embodiment.

FIG. 4 is a plan diagram depicting the form factor of a remote control according to an exemplary embodiment.

FIG. 5 is a flow chart depicting a method for interacting with race viewers according to an exemplary embodiment.

FIG. 6 is a flow chart depicting a method for receiving data related to an automobile race according to an exemplary embodiment.

FIG. 7 is a flow chart depicting a method for interacting with a race viewer according to an exemplary embodiment.

FIG. 8 is a flow chart depicting a method for interacting with a race viewer using real-time data according to an exemplary embodiment.

FIG. 9 is a flow chart depicting a method for receiving a race viewer's selection of desired data according to an exemplary embodiment.

FIG. 10 is a flow chart depicting a method for transmitting desired data based on a race viewer's selection according to an exemplary embodiment.

FIG. 11 is a flow chart depicting a method for presenting desired data to a race viewer according to an exemplary embodiment.

FIG. 12 is a flow chart depicting a method for interacting with a race viewer using broadcast content according to an exemplary embodiment.

### DETAILED DESCRIPTION OF THE EXEMPLARY EMBODIMENTS

The exemplary systems and methods described herein enable race viewers to interact with automobile races and advertising content shown during race broadcasts. Interacting with automobile races can include race viewers utilizing a remote control to receive data that includes audio communications of drivers participating in the race. The race viewers also can interact with the content broadcast during the race by utilizing the remote control to respond to questions about the race broadcast and advertisement shown during the race.

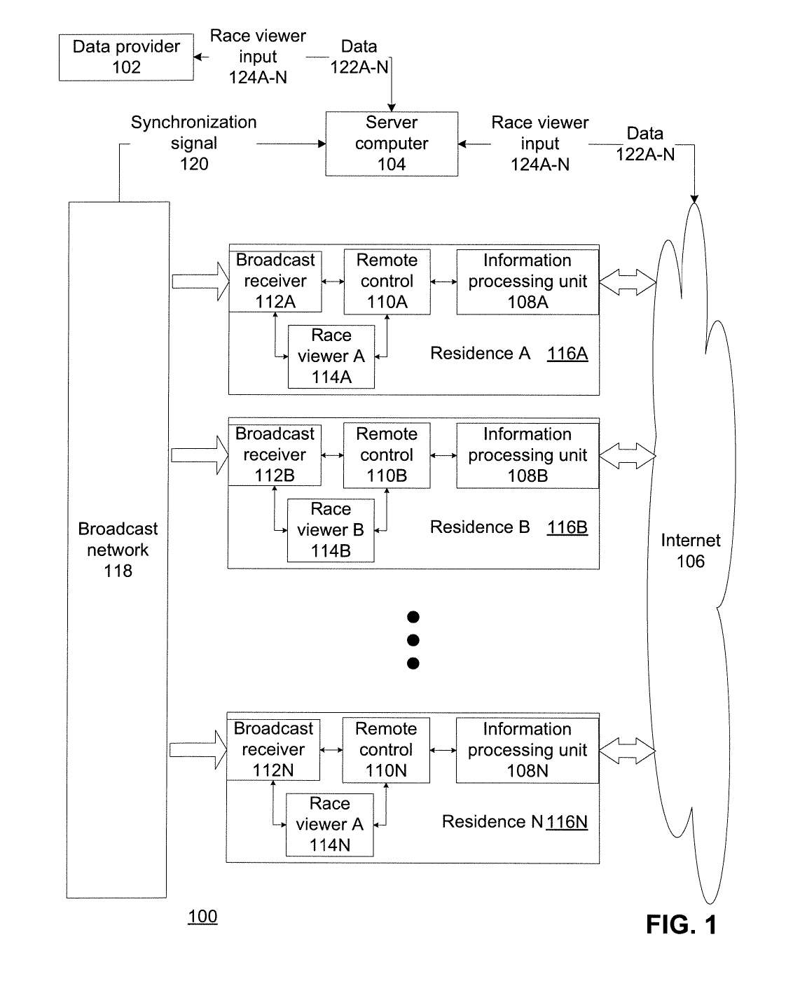

A method and system for interacting with automobile races and advertising content will now be described with reference to FIGS. 1-12, which depict representative or illustrative embodiments. FIGS. 1-4 are diagrams depicting components of systems for interacting with automobile races and advertising content according to exemplary embodiments.

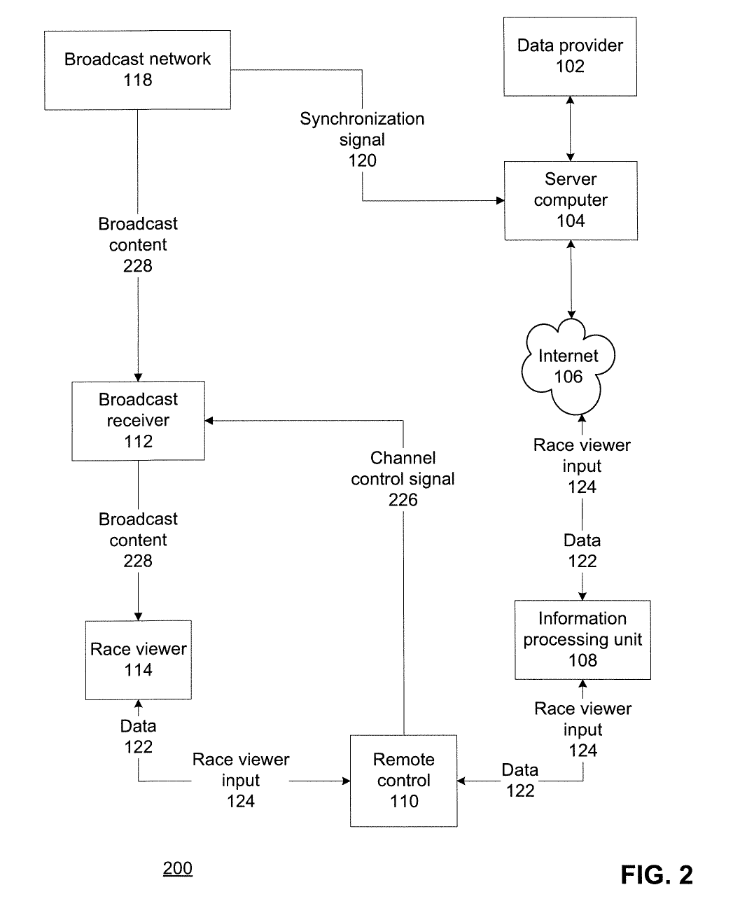

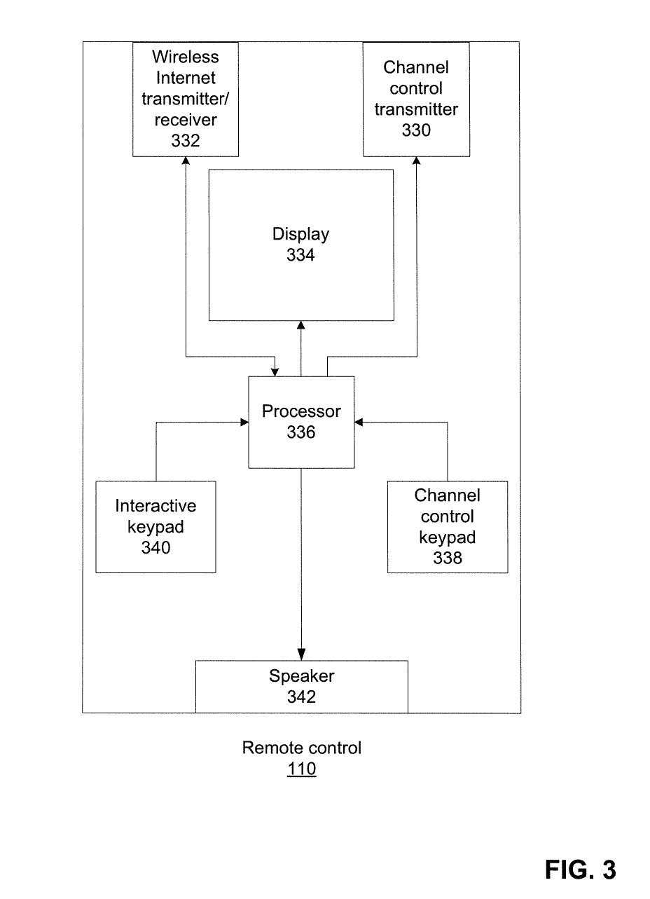

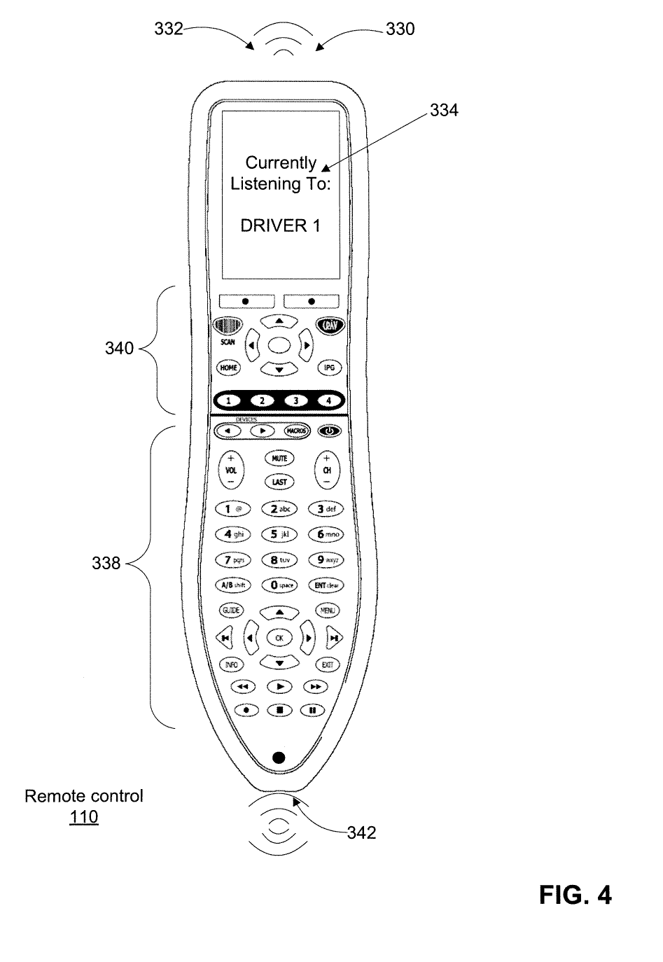

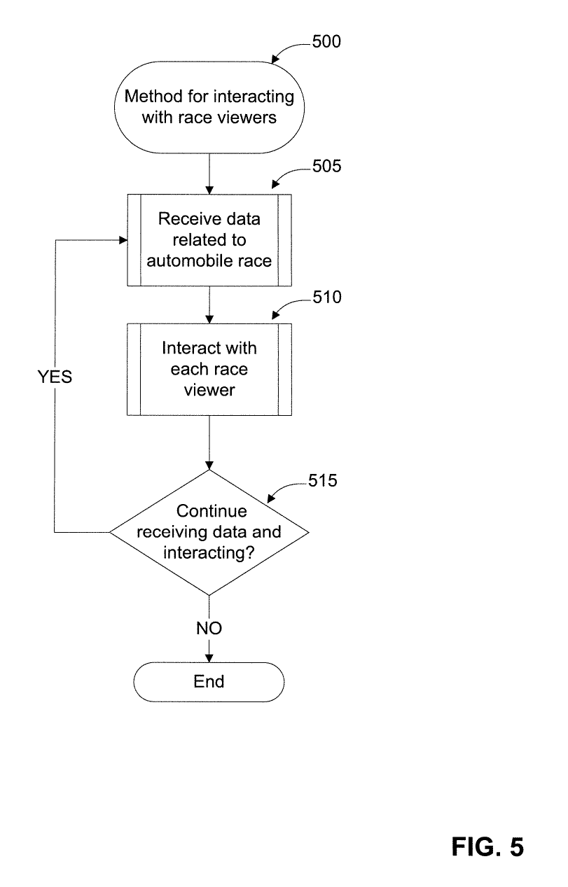

FIG. 1 is a block diagram depicting a system 100 for interacting with multiple race viewers 114A-N according to an exemplary embodiment. FIG. 2 is a block diagram depicting a system 200 for interacting with each race viewer 114 according to an exemplary embodiment. FIG. 3 is a block diagram depicting the components of a remote control 110 according to an exemplary embodiment. FIG. 4 is a plan diagram depicting the form factor of a remote control 110 according to an exemplary embodiment. The elements depicted in FIGS. 1-4 will be described in more detail with reference to the methods illustrated in FIGS. 5-12.

FIG. 5 is a flow chart depicting a method 500 for interacting with race viewers 114 according to an exemplary embodiment. The method 500 will be described with reference to FIGS. 1-5.

In step 505, data 122 related to an automobile race is received by a server computer 104. As used throughout the application, the term “data” includes any representation of information that can be transmitted and/or received by electronic information processing units. In an exemplary embodiment, data 122 can be received from a data provider 102, which is in informational communication with the server computer 104. In a particular embodiment, the data provider 102 can comprise a data storage center. In an alternative embodiment, the data provider 102 can comprise a service that collects or records data 122 from an automobile race and then provides the data 122 to the server computer 104. For example, a data provider 102 can tabulate statistics related to a race and then transmit those statistics to the server computer 104. A data provider 102 also can record audio communications between drivers participating in the race and their teams, and then transmit those records to the server computer 104. In addition to the communications, other sounds related to the automobile race, such as communication from an operator or manager of the race or background noise generally associated with the race, also can be presented to the race viewer 114 via the remote control 110.

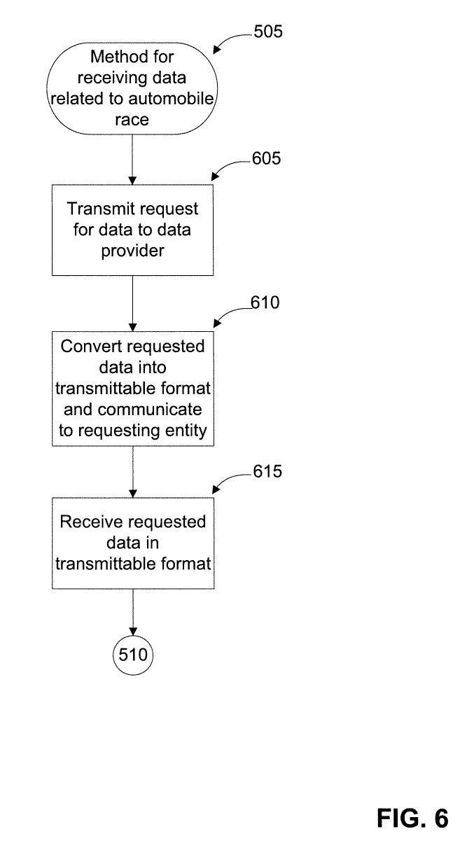

Step 505 will be described in more detail with reference to FIG. 6.

In step 510, each race viewer 114 interacts with the automobile race and advertising content 228. In exemplary embodiments, interacting with the automobile race and advertising content 228 can include various types of communication, such as receiving audio communications and other data 122 from an automobile race, as well as current and historical race statistics. Race viewers 114 also can interact with the automobile race and advertising content 228 by answering questions related to a broadcasted automobile race and the advertising shown during the broadcast.

In an exemplary embodiment, race viewers 114 can interact with the automobile race and advertising content 228 shown over a broadcast network 118 by utilizing a remote control 110. In a certain exemplary embodiment, as shown in FIG. 1, race viewers 114A-N, each residing in a separate residence 116A-N, can interact with automobile racing and advertising content 228 shown on a separate broadcast receiver 112A-N such as a television utilizing a separate remote control 110A-N. In an alternative exemplary embodiment, any given residence 116A-N may include multiple race viewers 114, each of whom may utilize a separate remote control 110 to interact with automobile racing and advertising content 228.

As illustrated in FIG. 3, the remote control 110 according to an exemplary embodiment can include various components for receiving data 122 relating to automobile race and advertising content 228, as well as for receiving input 124 from race viewers 114. In certain exemplary embodiments, the data 122 received by the remote control 110 can include audio communications between drivers and their teams, statistics for the automobile race being broadcasted, and historical data 122 relating to drivers participating in the race. In particular exemplary embodiments, race viewer input 124 can include the race viewer's 114 selection as to desired data to be received by the remote control 110 and the race viewer's 114 responses to questions relating to the automobile race and advertising shown during the broadcast.

In certain exemplary embodiments, the remote control 110 can include various features that allow race viewers 114 to interact with automobile racing and advertising content 228. In an exemplary embodiment, the remote control 110 can include a display 334 capable of displaying data 122 relating to automobile races to a race viewer 114. The data 122 displayed can include statistics or other information related to an automobile race occurring in real-time and/or historical data 122 relating to previous automobile races. The data 122 also can include one or more questions about the automobile race, advertisements, or other broadcast content 228.

In another exemplary embodiment, the remote control 110 also can include an audio output component. The audio output component can include a speaker 342, capable of presenting sound to individuals in proximity of the remote control 110. In exemplary embodiments, the remote control 110 can comprise an audio output component comprising a headphone jack (not shown), wherein a set of headphones can be connected to the remote control 110, and sound can be presented through the set of headphones. In certain embodiments, audio output through the speaker 342 can stop when a set of headphones is connected to the remote control 110. In other embodiments, audio output can continue through the speaker 342 after a set of headphones is connected to the remote control 110.

In another exemplary embodiment, the remote control 110 also can include a wireless Internet transmitter/receiver 332, that transmits race viewer input 124 to a server computer 104, and that receives data 122 from the server computer 104. In such an embodiment, the remote control 110 can communicate wirelessly with the server computer 104 via the Internet 106. In a particular embodiment, the wireless Internet 106 connection can comprise a WiFi or WiMax Internet 106 connection. As used throughout the application, the term “WiFi” refers to wireless Internet connections known to those in the art as based on any of the 802.11 specifications recognized by the Institute of Electrical and Electronics Engineers (IEEE) or equivalent past or future version, including “WiMax” or other suitable communication medium. In such an embodiment, the wireless Internet transmitter/receiver 332 can transmit and receive data 122 via a WiFi or WiMax Internet 106 signal when the remote control 110 is within the range of an active WiFi or WiMax Internet 106 signal, such as one generated by a wireless router in the race viewer's 114 residence 116.

In alternative embodiments, the wireless Internet 106 connection can comprise any wireless communication between the server computer 104 and the remote control 110, wherein the remote control 110 need not be in range of an active WiFi or WiMax Internet 106 signal to communicate with the server computer 104. Examples of types of such wireless communications are known to those in the art, and can include communications over CDMA, GSM, and/or GPRS networks, often used by cellular phone and mobile data providers 102 in communicating with their customers.

Regardless of the type of connection utilized by the remote control 110 in connecting to the Internet 106, the remote control 110 can, in a certain exemplary embodiment, access the Internet 106 through an Internet browser. Internet browsers are types of software that can be utilized by the remote control 110 in accessing the Internet 106. In these embodiments, the remote control 110 can access any number of servers connected to the Internet 106, in addition to the server computer 104.

Alternatively, in certain embodiments, the remote control 110 can communicate with the server computer 104 without a browser. In such an embodiment, the remote control 110 can include application software that provides a connection between the server computer 104 and the remote control 110. In a particular embodiment, the software can prevent access between the remote control 110 and servers other than the server computer 104.

In another alternative exemplary embodiment, the remote control 110 can communicate with the server computer 104 by communicating with a separate information processing unit 108, such as a personal computer, that is connected to the Internet 106. In such an embodiment, the remote control 110 may include a transmitter and receiver for communicating with an information processing unit 108, such as a personal computer, instead of or in addition to a wireless Internet transmitter/receiver 332. Data 122 can be transmitted from the server computer 104 to the information processing unit 108 via the Internet 106, and then from the information processing unit 108 to the remote control 110. Conversely, race viewer input 124 can be transmitted from the remote control 110 to the information processing unit 108, and then to the server computer 104 via the Internet 106.

In an exemplary embodiment, the remote control 110 also can include an interactive keypad 340. Race viewers 114 can utilize the interactive keypad 340 to select the data 122 they desire to receive on the remote control 110 and to enter responses to questions relating to the automobile race and advertising shown during the broadcast.

As illustrated in FIG. 4, the remote control 110 is designed in the compact form factor associated with a standard remote control and allowing one-handed operation of the remote control 110. As used herein, the term “remote control” refers to a handheld device that allows a race viewer 114 to control one or more electronic entertainment devices, such as a television, from a distance through one-handed operation. As used herein, “remote control” does not include such devices as personal computers, laptop computers, personal digital assistants and/or cellular phones that can be loaded with software and enabled to control electronic devices such as televisions.

Additionally, the remote control 110 includes features associated with standard remote controls. Specifically, the remote control 110 can include a channel control keypad 338 and a channel control transmitter 330 for operating a television and/or other household electronic devices. The remote control 110 then can transmit a channel control signal 226 to a broadcast receiver 112, such as a television. The size and shape of the remote control 110 can be similar to the size and shape of standard remote controls. In an exemplary embodiment, the remote control 110 can be ergonomically designed to fit comfortably in one hand of the operator and can allow one-handed operation.

The form factor and functionality of the remote control 110 can allow operators to replace other remote controls with this remote control 110, as people often do by utilizing a “universal” remote control. Additionally, the remote control's 110 ergonomic design and ability to send and receive data 122 via the Internet 106 encourages race viewers 114 to select this remote control 110 instead of other universal remote controls.

In still another exemplary embodiment, the remote control 110 also can include a processor 336. The processor 336 can be in informational communication with the other components of the remote control 110 described previously. For example, in an exemplary embodiment, the processor 336 can receive signals corresponding with race viewer input 124 from the interactive keypad 340 and the channel control keypad 338, and can transmit signals corresponding with data 122 to the display 334, speaker 342, and channel control transmitter 330. The processor 336 also can transmit race viewer input 124 to and receive data 122 from the wireless Internet transmitter/receiver 332.

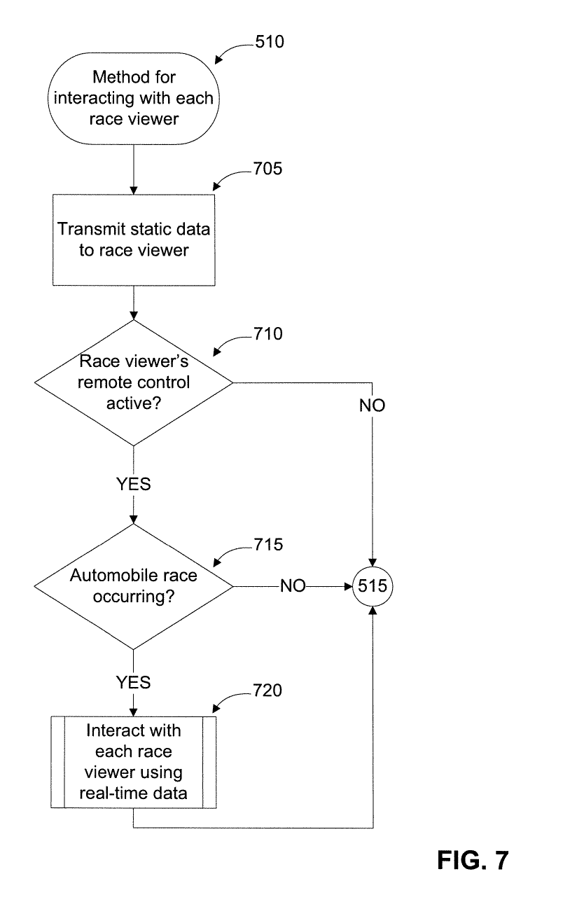

Step 510 will be described in more detail with reference to FIG. 7. From step 510, the method 500 proceeds to step 515.

In step 515, the method 500 determines whether to continue receiving data 122 and interacting with race viewers 114. If receiving data 122 and interacting is to continue, the method 500 returns to step 505. Otherwise, the method 500 ends. In an exemplary embodiment, the determination made in step 515 can be based on the time period for conducting an automobile race. For example, if the race is still in progress or within a predetermined time period after the race ends, then the method 500 can determine in step 515 to continue receiving data 122 and interacting with the viewer.

FIG. 6 is a flow chart depicting a method 505 for receiving data 122 related to an automobile race according to an exemplary embodiment, as referenced in step 505 of FIG. 5. The method 505 will be described with reference to FIGS. 1-4 and 6.

In step 605, a request for data 122 is transmitted by the server computer 104 to the data provider 102. As described previously, in various exemplary embodiments, a data provider 102 can comprise a data storage center or a service that collects or records data 122 from an automobile race and then provides the data 122 to the server computer 104. In certain embodiments, the request for data 122 can be based upon race viewer input 124 that indicates the type of data 122 certain race viewers 114 have requested. In other embodiments, the request can be for data 122 to be provided to all race viewers 114, regardless of whether the race viewers 114 have requested the data 122.

In step 610, the requested data 122 is converted into a transmittable format. In exemplary embodiments, the data 122 requested by the server computer 104 can be of various types and in various forms. For example, such data 122 can include statistics about an automobile race occurring in real-time or the audio communications between drivers and their teams. As used herein, “real-time” refers to events occurring approximately at the current instant. In an exemplary embodiment, the data provider 102 can convert these various types of data 122 into a transmittable format. For example, the data provider 102 can measure statistics related to the automobile race and enter them into an information processing unit 108 such as a computer. The data provider 102 also can record audio communications and convert them into any format that can be transmitted to the server computer 104. Examples of such formats include WAV, MP3, and WMA formats, any of which can be created by standard information processing units 108 running readily available software.

The data provider 102 also communicates the requested data to the server computer 104 as part of step 610. Accordingly, in step 615, the server computer 104 receives the data 122 it had requested in step 605. In an exemplary embodiment, the server computer 104 can convert the data 122 from its transmittable format into another format, organize and/or categorize the data 122, or otherwise process the data 122 in preparation for transmitting it to race viewers 114 and their corresponding remote controls 110. In an alternative exemplary embodiment, the server computer 104 can maintain the data 122 in the same format in which the server computer 104 receives the data 122. The method 505 then proceeds to step 510 (FIG. 5).

FIG. 7 is a flow chart depicting a method 510 for interacting with a race viewer 114 according to an exemplary embodiment, as referenced in step 510 of FIG. 5. The method 510 will be described with reference to FIGS. 1-4 and 7.

In step 705, the server computer 104 transmits static data 122 to a race viewer 114. In an exemplary embodiment, the server computer 104 can transmit static data 122 to the remote control 110 of the race viewer 114. In various exemplary embodiments, static data 122 can include updates to the software for the remote control 110, historical data 122 relating to previous races and/or drivers participating in an automobile race, or other data 122 that is independent of an automobile race occurring in real-time.

In an exemplary embodiment, such static data 122 can be “pushed” to the remote control 110. In other words, the static data 122 can be transmitted to the remote control 110 without the race viewer 114 actively or specifically requesting the data 122. Pushing such data 122 to the remote control 110 can increase efficiency in utilizing the remote control 110, as doing so can reduce the bandwidth needed to transmit data 122 related to automobile races occurring in real-time.

In step 710, the method 510 determines whether the race viewer's 114 remote control 110 is active. If the remote control 110 is not active, the method 510 branches to step 515 (FIG. 5). If the remote control 110 is active, the method 510 branches to step 715. In an exemplary embodiment, the determination made in step 710 can be the result of the server computer 104 interrogating the remote control 110. The remote control 110 then can respond to the interrogation, indicating the status (i.e., active or not active) of the remote control 110. As used throughout the application, the term “active” refers to a state of the remote control 110 where the race viewer is utilizing the remote control 110 to interact with an automobile race. In an exemplary embodiment, when the remote control 110 is not active, the display 334 and/or speaker 342 can be off or not in use, but the processor 336 can remain functional.

The method 510 as illustrated in FIG. 7 can transmit static data 122 to race viewers 114 even if the race viewer's 114 remote control 110 is not active. In an alternative exemplary embodiment, static data 122 is not transmitted to the race viewer's 114 remote control 110 unless it is active. Such an exemplary embodiment could be achieved by swapping steps 705 and 710.

In step 715, the method 510 determines whether an automobile race is occurring. For example, the server computer 104 can read a broadcast schedule or receive an input indicating that an automobile race is occurring and is being broadcast via the broadcast network 118. If an automobile race is not occurring, then the method 510 branches to step 515 (FIG. 5). If an automobile race is occurring, then the method 510 branches to step 720.

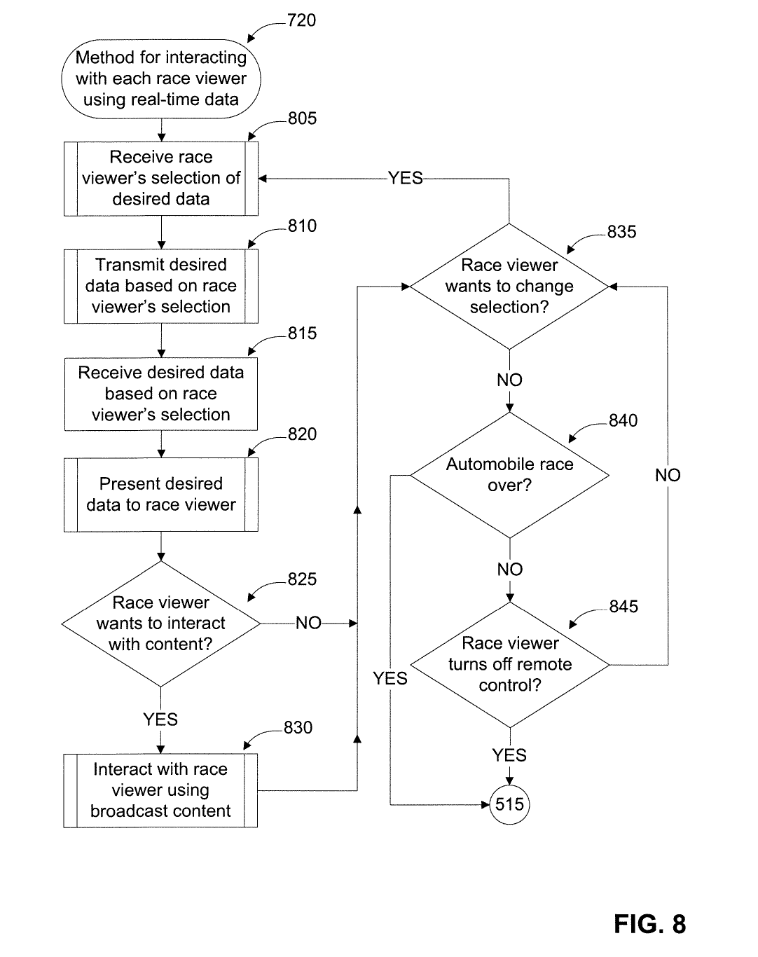

In step 720, each race viewer 114 interacts with the automobile racing broadcast content 228 occurring in real-time using real-time data 122. This real-time data 122 can include statistics related to the automobile race occurring in real-time, as well as audio communications between drivers and their teams. Step 720 will be described in more detail with reference to FIG. 8. After step 720, the method 510 proceeds to step 515 (FIG. 5).

FIG. 8 is a flow chart depicting a method 720 for interacting with a race viewer 114 using real-time data 122 according to an exemplary embodiment, as referenced in step 720 of FIG. 7. The method 720 will be described with reference to FIGS. 1-4 and 8.

The method 720 can be performed for particular ones of the race viewers 114. Accordingly, the method 720 is described from the perspective of a single race viewer 114. The method 720 can be repeated for each respective race viewer 114 that desires to participate.

In step 805, the server computer 104 receives the race viewer's 114 selection of desired data. In an exemplary embodiment, the race viewer 114 can utilize the remote control 110 to select the types of data 122 that the race viewer 114 desires to receive. The remote control 110 then can transmit race viewer input 124 corresponding with the selection of desired data to the server computer 104 via the Internet 106.

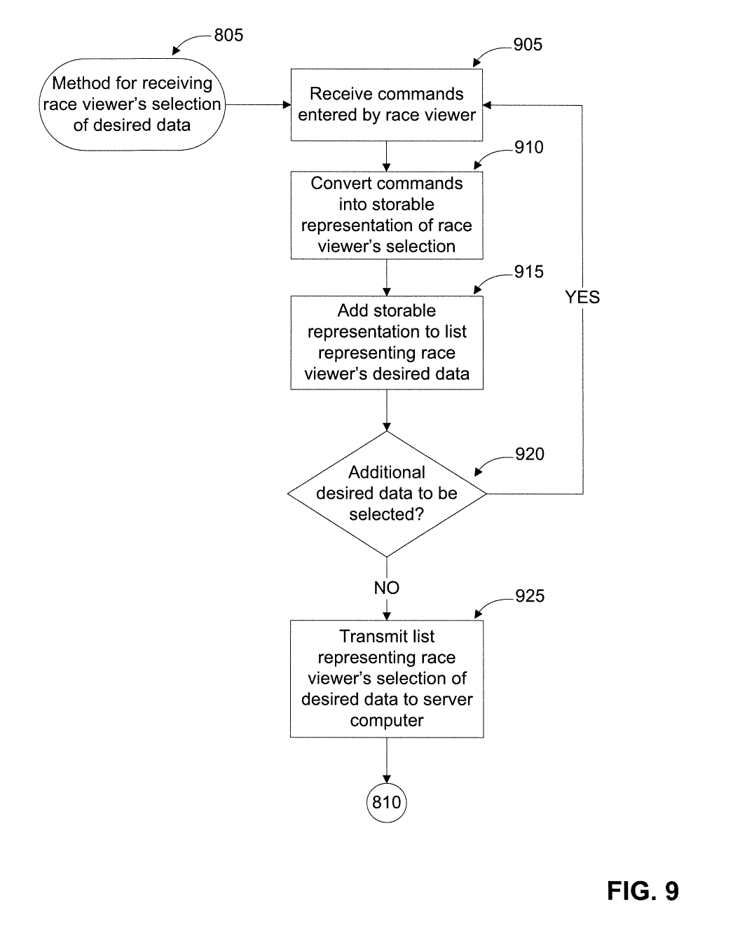

In exemplary embodiments, race viewers 114 can select various types of data 122 to receive on the remote control 110. For example, the race viewer 114 can select to receive the audio communications of one or more drivers' teams. The race viewer 114 also can select to receive particular types of statistics concerning the automobile race. In a particular embodiment, the race viewer 114 also can select to receive certain historical data 122 that the race viewer's 114 remote control 110 has not previously received. Step 805 will be described in more detail hereinafter with reference to FIG. 9.

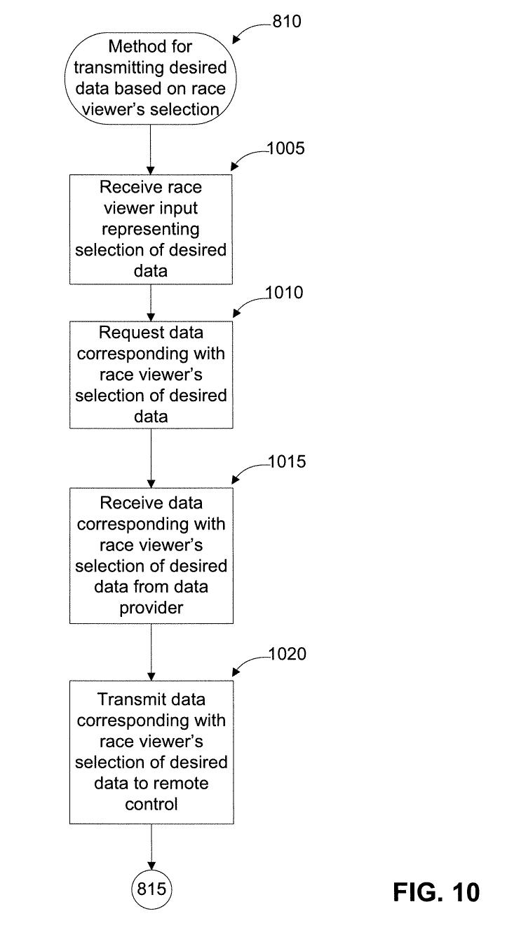

In step 810, the server computer 104 transmits the desired data to the race viewer's 114 remote control 110 based upon the race viewer's 114 selection of desired data described in step 805. Step 810 will be described in more detail with reference to FIG. 10.

In step 815, the remote control 110 receives the desired data, as determined by the race viewer's 114 selection described in step 805. In an exemplary embodiment, the remote control 110 also can receive additional data 122, beyond what the race viewer 114 selected in step 805, such as data corresponding to or enhancing the race viewer's 114 selection described in step 805.

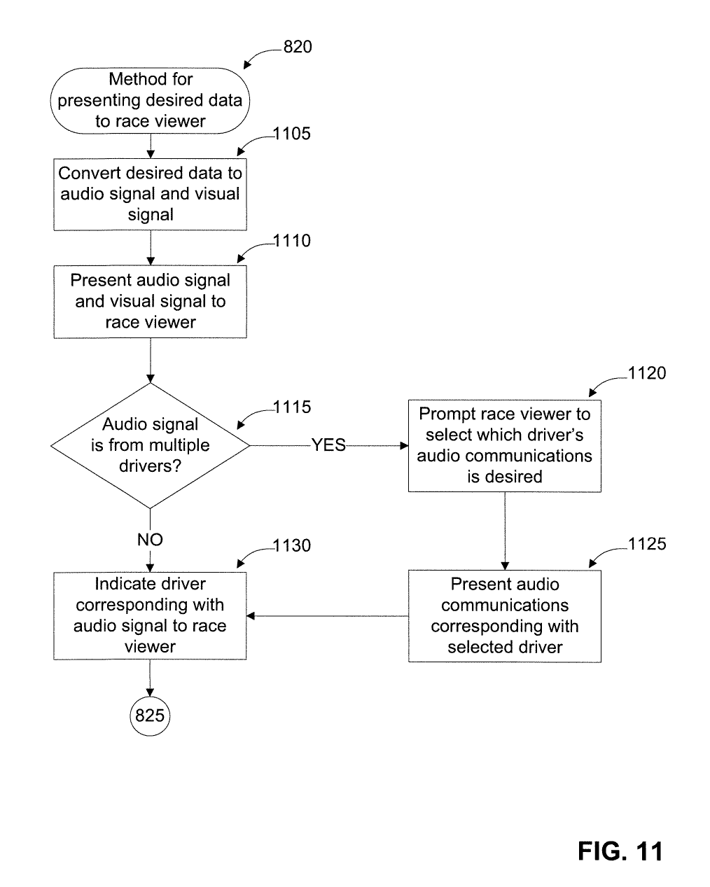

In step 820, the remote control 110 presents the desired data that was received in step 815 to the race viewer 114. In exemplary embodiments, the remote control 110 can present the data 122 both audibly and visually. For example, some of the data 122 can include audio communications between drivers and their teams, which can be presented audibly through the speaker 342. Other data 122 can include statistics relating to the race or pictures of drivers or cars from the race, which can be presented visually on the display 334. In exemplary embodiments, the transmitter/receiver 332 of the remote control 110 can receive the data 122 and can forward the data 122 to the processor 336. Then, the processor 336 can communicate the data 122 to the display 334 and/or the speaker 342 for presentation to the race viewer 114 in step 820. Step 820 will be described in more detail with reference to FIG. 11.

In step 825, the method 720 determines whether the race viewer 114 wants to interact with broadcast content 228 shown on the broadcast receiver 112 via the broadcast network 118. In an exemplary embodiment, determining whether the race viewer 114 wants to interact with broadcast content 228 can include prompting the race viewer 114 via the remote control 110 to select whether or not the race viewer 114 wants to interact with broadcast content 228, and then receiving and processing this selection.

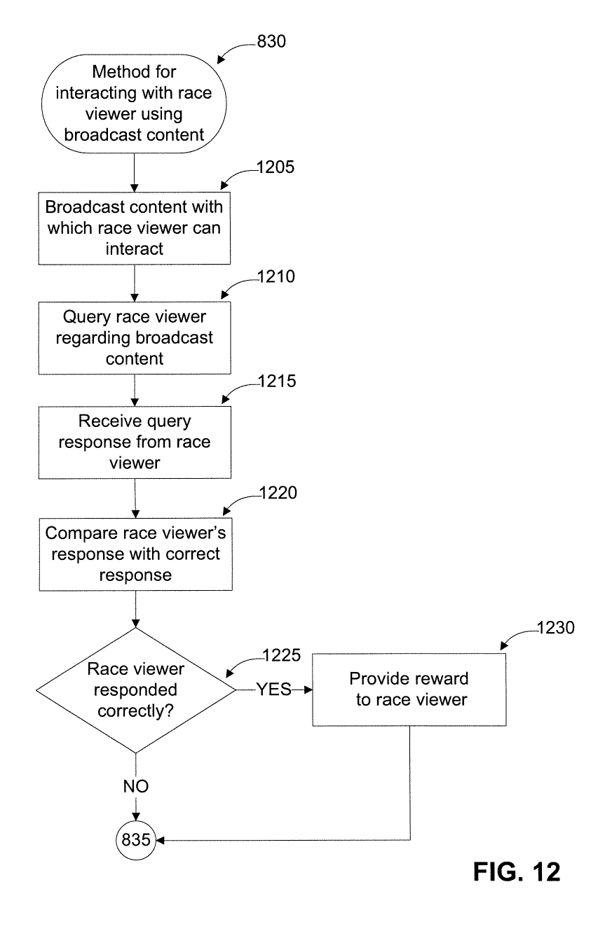

In exemplary embodiments, interacting with broadcast content 228 shown on the broadcast receiver 112 can include the race viewer 114 responding to questions concerning the automobile race, advertisement shown during the race, or other broadcast content 228. If the race viewer 114 wants to interact with broadcast content 228, the method 720 branches to step 830, where the race viewer 114 interacts with the broadcast content 228. In an exemplary embodiment, the method 720 can present one or more questions regarding the broadcast content 228 and can determine that the race viewer 114 wants to interact with the broadcast content 228 if the race viewer 114 responds to the questions. Step 830 will be described in more detail with reference to FIG. 12.

If the race viewer 114 does not want to interact with broadcast content 228, the method 720 branches to step 835, where the method 720 determines whether the race viewer 114 wants to change the selection of desired data. In an exemplary embodiment, determining whether the race viewer 114 wants to change the selection of desired data can include receiving any race viewer input 124 from the race viewer 114 that indicates a desire to change the selection. If such race viewer input 124 is not received, the method 720 can conclude that the race viewer 114 does not want to change the selection of desired data. If the race viewer 114 wants to change the selection, the method 720 returns to step 805. Otherwise, the method 720 branches to step 840.

In step 840, the method 720 determines whether the automobile race occurring in real-time is over. If the automobile race is over, the method 720 branches to step 515 (FIG. 5). Otherwise the method 720 branches to step 845. In an exemplary embodiment, the determination made in step 840 can be based on the time period for conducting an automobile race. For example, if the race is still in progress or within a predetermined time period after the race ends, then the method 720 can determine in step 840 to continue receiving data 122 and interacting with the race viewer 114.

In step 845, the method 720 determines whether the race viewer 114 has turned off the power to the remote control 110. If the race viewer 114 has turned off the remote control 110, the method 720 branches to step 515 (FIG. 5). Otherwise, the method 720 returns to step 835, discussed previously. In an exemplary embodiment, the determination made in step 845 can be the result of the server computer 104 interrogating the remote control 110. If the remote control 110 responds to the interrogation, then the method 720 can determine that the race viewer 114 has not turned off the power to the remote control 110. If a response is not received, then the method 720 can determine that the race viewer 114 has turned off the power to the remote control 110.

FIG. 9 is a flow chart depicting a method 805 for receiving a race viewer's 114 selection of desired data according to an exemplary embodiment, as referenced in step 805 of FIG. 8. The method 805 will be described with reference to FIGS. 1-4 and 9.

In step 905, commands entered by the race viewer 114 are received. In an exemplary embodiment, a race viewer 114 can utilize the interactive keypad 340 on the remote control 110 to enter the race viewer input 124 corresponding with the race viewer's 114 selection of desired data. In an exemplary embodiment, the processor 336 of the remote control 110 can receive signals from the interactive keypad 340 corresponding with the commands entered by the race viewer 114. In step 910, the processor 336 converts the commands entered by the race viewer 114 into a storable representation of the race viewer's 114 selection indicated by the race viewer input 124.

In a certain exemplary embodiment, the remote control 110 can present graphical and/or textual menus to the race viewer 114 via the display 334 to help the race viewer 114 select the data 122 desired. In an alternative exemplary embodiment, the race viewer 114 can enter the car numbers of the drivers for whom data 122, such as audio communications, is desired. In another exemplary embodiment, the remote control 110 also can display a confirmation message before converting the race viewer's input 124 of commands to a representation of the race viewer's 114 desired data.

In step 915, the storable representations of the race viewer's 114 selection of desired data can be added to a list that represents the types of data 122 that the race viewer 114 desires to receive. In an exemplary embodiment, if the race viewer 114 has not yet selected any desired data, the list can be empty. In an alternative exemplary embodiment, if the race viewer 114 has not yet selected any desired data, the list can include various types of default desired data that the remote control 110 will receive from the server computer 104.

In step 920, the method 805 determines whether additional types of desired data are to be selected by the race viewer 114. In an exemplary embodiment, the method 805 can prompt the race viewer 114 to select whether or not additional types of desired data should be presented to the race viewer 114. If the race viewer 114 wants to select additional desired data to receive, the method 805 returns to step 905. Otherwise, the method 805 branches to step 925.

In step 925, the method 925 transmits the list representing the race viewer's 114 selections of desired data to the server computer 104. In an exemplary embodiment, this list can be transmitted to the server computer 104 via the Internet 106. As described previously, the remote control 110 can transmit race viewer input 124, such as the list, to the server computer 104 via the wireless Internet transmitter/receiver 332. In an alternative embodiment, as described previously, the remote control 110 can transmit race viewer input 124 to an information processing unit 108 connected to the Internet 106, which in turn can transmit the race viewer input 124 to the server computer 104. The method 925 then proceeds to step 810.

FIG. 10 is a flow chart depicting a method 810 for transmitting desired data based on a race viewer's 114 selection according to an exemplary embodiment, as referenced in step 810 of FIG. 8. The method 810 will be described with reference to FIGS. 1-4 and 10.

In step 1005, the server computer 104 receives race viewer input 124 representing the race viewer's 114 selection of desired data. In exemplary embodiments, as described previously, the race viewer's 114 selection of desired data can include requests for audio communications between drivers and their teams and statistics related to the automobile race.

In step 1010, the server computer 104 requests the data 122 that corresponds with the race viewer's 114 selection of desired data from the data provider 102. In one exemplary embodiment, the server computer 104 can request all of the data 122 that corresponds with the race viewer's 114 selection from one data provider 102. In an alternative exemplary embodiment, the server computer 104 can request different types of data 122 from different data providers 102. For example, the server computer 104 can request audio communications from one data provider 102, statistics and information relating to a race occurring in real-time from another data provider 102, and historical data 122 from a third data provider 102.

In another exemplary embodiment, the server computer 104 can combine all of the race viewer input 124A-N from multiple race viewers 114A-N when requesting data 122A-N from the data providers 102. For example, if multiple race viewers 114A-N requested the same data 122A-N, the server computer 104 may request that data 122A-N from the data provider 102 only once.

In an alternative exemplary embodiment, the server computer 104 can request certain data 122 from data providers 102 without waiting for particular race viewers 114 to select to receive such data 122. For example, certain types of data 122, such as the audio communications between drivers and their teams, may be so commonly requested that the server computer 104 can request that data 122 from the data provider 102 before any particular race viewer 114 has selected to receive that data 122.

In step 1015, the server computer 104 receives the data 122 corresponding with the race viewer's 114 selection of desired data from the data providers 102. In exemplary embodiments, communications including data 122 and race viewer input 124 can be transmitted between the data provider 102 and the server computer 104 according to various methods. In one exemplary embodiment, the data provider 102 and server computer 104 can communicate via a network, such as the Internet 106. In another exemplary embodiment, data 122 from the data provider 102 can be manually entered into the server computer 104.

In step 1020, the server computer 104 transmits data 122 corresponding with the race viewer's 114 selection of desired data to the race viewer's 114 remote control 110. As described previously, in an exemplary embodiment, the data 122 can be transmitted to the remote control 110 via a network, such as the Internet 106. In exemplary embodiments, the remote control 110 can receive the data 122 directly from the server computer 104, or alternatively, the remote control 110 can receive the data 122 from an information processing unit 108 that received the data 122 from the server computer 104. The method 810 then proceeds to step 815 (FIG. 8).

FIG. 11 is a flow chart depicting a method 820 for presenting desired data to a race viewer 114 according to an exemplary embodiment, as referenced in step 820 of FIG. 8. The method 820 will be described with reference to FIGS. 1-4 and 11.

In step 1105, the remote control 110 converts the desired data received from the server computer 104 into audio and visual signals. In an exemplary embodiment, the wireless Internet transmitter/receiver 332 receives the desired data and then transmits it to the processor 336. The processor 336 then can determine the contents of the desired data, transmit audio signals corresponding with the data 122 to the speaker 342, and transmit visual signals corresponding with the data 122 to the display 334.

In step 1110, the remote control 110 presents the audio and visual signals to the race viewer 114. In one exemplary embodiment, the display 334 can receive the visual signals from the processor 336 and display data 122 based upon the signal. The display 334 can include statistics from the automobile race, pictures from the race, pictures of drivers, historical data 122, and/or any other suitable type of data 122 that can be presented visually.

In another exemplary embodiment, the speaker 342 can receive the audio signals from the processor 336 and convert the audio signals into sound. The sound can include the audio communications between one or more drivers participating in an automobile race and their teams. In a particular exemplary embodiment, as described previously, the remote control 110 can include a headphone jack, wherein a set of headphones can be connected to the remote control 110, and sound can be presented through the set of headphones. In another exemplary embodiment, audio output through the speaker 342 can stop when a set of headphones is connected to the remote control 110. In an alternative exemplary embodiment, audio output can continue through the speaker 342 after a set of headphones is connected to the remote control 110.

In step 1115, the method 820 determines whether the audio signal being presented is from multiple drivers. If the method 820 determines that the audio signal includes communications from multiple drivers and their teams, the method 820 branches to step 1120. Otherwise, the method 820 branches to step 1130, where the remote control 110 indicates to the race viewer 114 the driver that corresponds with the audio signal being presented on the speaker 342, by presenting on the display 334 an indication of the corresponding driver.

In an exemplary embodiment, the method 820 can determine whether the audio signal being presented is from multiple drivers by transmitting a signal to the remote control 110 that indicates the drivers whose audio communications are being presented to the remote control 110. The processor 336 then can receive this signal to determine whether the audio signal is from multiple drivers, and if so, the identities of those drivers. In another exemplary embodiment, the signal that indicates the drivers whose audio communications are being presented to the remote control 110 can be based upon the frequency at which the various drivers communicate. Because each driver may use a different frequency to communicate with his or her team, the data provider 102 can send a signal based upon this frequency to the server computer 104 along with the audio communications of the corresponding driver. In this regard, each driver communication can have a corresponding frequency (or other identifier) associated with that communication to identify the specific driver whose team is communicating. The server computer 104 then can send the signals and audio communications to the remote control 110, which then can indicate the identity of the driver or drivers associated with each audio signals. Thus, as multiple audio signals are received, the processor 336 can receive each audio communication and its corresponding identifier signal in sequence, read the driver identifier associated with the first audio communication in the sequence, present the audio communication via the speaker 342, and present an identification of the driver via the display 334. After the first audio communication ends (or if another audio communication interrupts or talks “over” the audio communication being presented), the processor 336 can repeat that procedure for each subsequent audio communication to read the driver identifier associated with the next audio communication in the sequence, present the audio communication via the speaker 342, and present an identification of the driver for the currently presented audio communication via the display 334.

In step 1120, the remote control 110 prompts the race viewer 114 to select which of the multiple drivers' communications the race viewer 114 desires to hear. In an exemplary embodiment, the display 334 of the remote control 110 can list the names of the drivers whose audio communications can be presented through the speaker 342. In another exemplary embodiment, the display 334 can show pictures associated with the drivers whose audio communications are being presented. Regardless of how the remote control 110 informs the race viewer 114 which drivers' communications are available to be presented, the race viewer 114 can utilize the interactive keypad 340 to select which driver's communications should be presented on the speaker 342.

In a particular exemplary embodiment, the race viewer 114 can select a set or “pack” of drivers whose communications the race viewer 114 desires to hear. In various embodiments, the types of packs can include the top five or top ten drivers in the race at any given time, a subset of drivers that are tied or very close to each other at any given time, a subset of drivers that all drive the same make of automobile, a subset of drivers that comprise a team, or any other suitable related set of drivers. In an exemplary embodiment, the data provider 102 can indicate to the server computer 104 the packs that are available for selection and the drivers that are in any given pack. For example, the data provider 102 can continually monitor the race and continuously update a list of the top five or top ten drivers, and then communicate that list along with a list of static packs (such as team packs and car make packs) to the server computer 104. Then, the server computer 104 can communicate the list of available packs (and drivers included in those packs) to the remote control 110 for presentation to the race viewer 114 via the display 334. In another exemplary embodiment, the server computer 104 or an operator of the server computer 104 can monitor the race and continuously update the list of the top five or top ten drivers along with the static packs and then communicate that list to the remote control 110 for presentation to the race viewer 114 via the display 334. In various exemplary embodiments, the race viewer 114 can select a desired pack by methods similar to the methods for selecting desired data described previously with respect to step 905.

In step 1125, the remote control 110 presents the audio signal corresponding with the driver selected in step 1120.

In step 1130, the remote control 110 indicates to the race viewer 114 the driver that corresponds with the audio signal being presented. In an exemplary embodiment, the remote control 110 can indicate the appropriate driver by displaying a picture of the driver, the driver's name, the driver's team number, the driver's team name, and/or the brand logo corresponding with the driver's team.

In an alternative exemplary embodiment, instead of prompting the race viewer 114 to select one driver's audio communications to present through the speaker 342, the remote control 110 can present more than one drivers' audio communications simultaneously. In a particular embodiment, race viewers 114 can select multiple drivers or a “pack” of drivers in an automobile race, and the communications of each of the multiple drivers' teams will be presented by the remote control 110. In such an embodiment, the remote control 110 can indicate to the race viewer 114 the identities of all of the drivers whose team communications are being presented by the remote control 110 at the current instant. Additionally, in such an embodiment, there can be instances where a portion of the selected drivers' teams are not communicating, and therefore, no communication from the portion of teams will be presented by the remote control 110 during those instances. As described previously, the remote control 110 can determine which driver or drivers have team communications being presented at any given time by processing the signals sent by the data provider 102 that can indicate the driver associated with any audio communication. Also as described previously, the remove control 110 can indicate the appropriate driver or drivers to the race viewer 114 by displaying a picture of the driver, the driver's name, the driver's team number, the driver's team name, and/or the brand logo corresponding with the driver's team.

In another exemplary embodiment, the remote control 110 can indicate the driver or drivers whose communications are being presented at any given time by displaying a visual representation of the sound waves associated with the communications together with an indication of the driver (such as with a picture or name of the driver). Such an indicator could help the race viewer 114 distinguish between background noise being presented (which may have a substantially flat sound wave) and actual communications (which may have a sound wave with more fluctuation).

The method 820 then proceeds to step 825 (FIG. 8).

FIG. 12 is a flow chart depicting a method 830 for interacting with a race viewer 114 using broadcast content 228 according to an exemplary embodiment, as referenced in step 830 of FIG. 8. The method 830 will be described with reference to FIGS. 1-4 and 12.

In step 1205, the broadcast network 118 broadcasts content 228 with which the race viewer 114 can interact. In an exemplary embodiment, race viewers 114 can interact with various types of broadcast content 228 communicated via the broadcast network 118 and viewed by the race viewer 114 via a broadcast receiver 112 such as a television. As described previously, in a particular exemplary embodiment, race viewers 114 can interact with the automobile race and advertising content 228 by answering questions related to a broadcasted automobile race and the advertising shown during the broadcast.

In a particular embodiment, the broadcast content 228 can include a split screen. In such an embodiment, the automobile race can be displayed on a first part of a screen of a broadcast receiver 112, and advertisements and/or questions about the broadcast content 228 can be displayed on a second part of the screen.

In step 1210, the server computer 104 queries the race viewer 114 regarding the broadcast content 228. In an exemplary embodiment, the server computer 104 can be synchronized with the broadcast network 118 before querying the race viewer 114 regarding the broadcast content 228. In a particular exemplary embodiment, the server computer 104 can be synchronized with the broadcast network 118 by receiving a synchronization signal 120 from the broadcast network 118. The synchronization signal 120 can include any data 122 that indicates the broadcast content 228 being shown on the broadcast network 118 at a given time. In an exemplary embodiment, such a signal can enable the server computer 104 to determine the broadcast content 228 the race viewer 114 is watching and to query the race viewer 114 about the broadcast content 228 recently viewed.

In exemplary embodiments, the query can be presented to the race viewer 114 in a variety of ways. For example, the query can be presented to the race viewer 114 by one or more of (a) appearing on the broadcast receiver 112 during an automobile race; (b) appearing on the broadcast receiver 112 during a commercial break; (c) being displayed on the remote control 110; (d) requesting the race viewer 114 to utilize an information processing unit 108, such as a personal computer, with an Internet 106 connection to obtain the questions; and/or (e) requesting the race viewer 114 to call a telephone number and verbally presenting the questions over the telephone.

In step 1215, the server computer 104 receives the query response from the race viewer 114. In exemplary embodiments, the race viewer 114 can respond to the query in a variety of ways, regardless of how the query was presented to the race viewer 114. For example, the race viewer 114 can respond to the query by one or more of (a) utilizing the interactive keypad 340 of the remote control 110 to enter the response into the remote control 110 for communication to the server computer 104 via the Internet 106; (b) utilizing an information processing unit 108 with an Internet 106 connection to enter the response, which is then communicated to the server computer 104 via the Internet 106; and/or (c) utilizing a telephone to respond to the query, either verbally or by utilizing the key pad of a touch-tone phone.

In step 1220, the server computer 104 compares the race viewer's 114 response to the query with the correct response. In an exemplary embodiment, the server computer 104 maintains a list or database of various queries that it has asked to the race viewer 114 with the corresponding answers. In another exemplary embodiment, the server computer 104 can determine what query was presented to the race viewer 114, determine the correct response for that query, and then compare the race viewer's 114 response with the correct response.

In step 1225, the method 830 determines whether the race viewer 114 responded to the query correctly. If the race viewer 114 responded correctly, the method 830 branches to step 1230. Otherwise, the method 830 proceeds to step 835 (FIG. 8). In an exemplary embodiment, determining whether the race viewer 114 responded correctly can include the server computer 104 determining whether the race viewer's 114 response matches the correct response. In another exemplary embodiment, the server computer 104 can determine whether the race viewer's 114 response is approximately equivalent to the correct response to determine that the race viewer 114 responded correctly to the query.

In step 1230, the race viewer 114 is provided with a reward for answering the query correctly. In exemplary embodiments, rewarding the race viewer 114 can include reducing and/or removing any fee otherwise charged to race viewers 114, and/or providing coupons, free samples, prizes, cash awards, discounts, or other suitable rewards. In a particular embodiment, the possibility of earning desirable rewards can encourage race viewers 114 to interact with the broadcast content 228, which can enhance the race viewer's 114 immersion in and the value of advertising during the racing broadcast.

The foregoing exemplary embodiments largely described race viewers 114 utilizing a remote control 110 to receive data 122 and otherwise interact with automobile races and advertising content 228 shown on a broadcast receiver 112. According to one of the foregoing embodiments described previously, race viewers 114 can utilize the remote control 110 to receive the communications of multiple drivers simultaneously. In alternative exemplary embodiments, race viewers 114 can utilize a variety of devices to receive the communications of multiple drivers simultaneously, not solely the remote control 110. In such embodiments, race viewers 114 can utilize any device that is capable of receiving data 122 over the Internet or any other communication medium and has a display for indicating the driver or drivers whose audio communications are being presented to the race viewer 114 at any given time.

In one exemplary embodiment, a race viewer 114 can utilize an information processing unit with an Internet connection to receive the audio communications of multiple drivers participating in an automobile race. As used throughout the application, the term “Internet connection” includes any software application and hardware device that is used to connect remote clients to the Internet. Those skilled in the art will recognize that the remote clients and the servers can establish an Internet connection using one of several methods known in the art. For the purpose of this application, it is only relevant to understand that the remote clients and servers are respectively connected with each other through the Internet connection.

In an alternative exemplary embodiment, a race viewer 114 can utilize a satellite radio receiver to receive the audio communications, and the display of the receiver can indicate the identity of the driver or drivers communicating at any given time.

The exemplary methods and steps described in the embodiments presented previously are illustrative, and, in alternative embodiments, certain steps can be performed in a different order, in parallel with one another, omitted entirely, and/or combined between different exemplary methods, and/or certain additional steps can be performed, without departing from the scope and spirit. Accordingly, such alternative embodiments are implicitly included in the invention described herein.

The invention can be used with computer hardware and software that performs some of the methods and processing functions described above. As will be appreciated by those skilled in the art, some of the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope defined in the following claims, the scope of which is to be accorded the broadest interpretation so as to encompass such modifications and equivalent structures.

What is claimed is:

1. A remote control device for receiving data related to an automobile race, comprising:
a receiver for receiving data related to the automobile race from a server computer;
an interactive keypad for receiving input from a viewer operating the remote control device;
a transmitter for transmitting the input from the viewer to the server computer; and
a processor in informational communication with the receiver, the interactive keypad, and the transmitter;
wherein the remote control device has a form factor of a standard remote control and wherein the form factor permits one-handed operation of the remote control device by the viewer.

2. The remote control device of claim 1, further comprising:
a speaker; and
a display;
wherein the speaker and the display are in informational communication with the processor and are operable to present the data related to the automobile race to the viewer.

3. The remote control device of claim 1, further comprising:
a channel control keypad; and
a channel control transmitter;
wherein the channel control transmitter and the channel control keypad are in informational communication with the processor and operable to receive the viewer's input via the channel control keypad and to communicate via the channel control transmitter a channel control signal for controlling a broadcast receiver.

4. The remote control device of claim 1, wherein the data comprises audio communications of drivers participating in the automobile race.

5. The remote control device of claim 1, wherein the data comprises audio communications of at least two drivers participating in the automobile race.

6. The remote control device of claim 1, wherein the data comprises statistics related to the automobile race.

7. The remote control device of claim 1, wherein:
the automobile race and advertisements are broadcast over a broadcast network;
the data comprises a question based upon the automobile race or advertisements broadcast over the broadcast network; and
the input comprises a response by the viewer to the question.

8. A method for interacting with a viewer of an automobile race, comprising the steps of:
transmitting data related to an automobile race to a remote control device;
receiving the data with the remote control device; and
presenting the data to the viewer;
wherein the remote control device has a form factor of a standard remote control and wherein the form factor permits one-handed operation of the remote control device by the viewer.

9. The method of claim 8, wherein the step of presenting the data to the viewer comprises the steps of:
presenting data audibly through a speaker of the remote control device; and
presenting data visually on a display of the remote control device.

10. The method of claim 8, wherein the data comprises audio communications of at least one driver participating in the automobile race.

11. The method of claim 10, further comprising the step of indicating to the viewer the at least one driver corresponding with the audio communications.

12. The method of claim 8, wherein the data comprises audio communications of at least two drivers participating in the automobile race, and wherein the method further comprises the steps of:
presenting the audio communications to the viewer at a given time; and
indicating to the viewer identities of the drivers whose audio communications are being presented to the viewer at the given time.

13. The method of claim 12, wherein the at least two drivers are in a pack of drivers.

14. The method of claim 8, further comprising the steps of:
presenting broadcast content to the viewer;
presenting the viewer with a question about the broadcast content, the question having a correct response;
receiving the viewer's response to the question;
comparing the viewer's response with a correct response; and
if the viewer's response is substantially equivalent to the correct response, awarding the viewer with a reward.

15. A method for presenting audio communications of automobile race drivers to a viewer of the automobile race, comprising the steps of:
transmitting data comprising the audio communications of at least two automobile race drivers to a device;
receiving the data with the device;
presenting the data to the viewer at a given time; and
indicating to the viewer identities of the automobile race drivers whose audio communications are being presented to the viewer at the given time.

16. The method of claim 15, wherein the at least two automobile race drivers are in a pack of drivers.

17. The method of claim 15, wherein the device has a form factor resembling a remote control device and wherein the form factor permits one-handed operation of the device by the viewer.

18. The method of claim 15, wherein the data further comprises statistics related to the automobile race, and the method further comprising the steps of:
receiving the data with the device; and
presenting the data to the viewer.

19. The method of claim 15, further comprising the steps of:
presenting broadcast content to the viewer;
presenting the viewer with a question about the broadcast content, the question having a correct response;
receiving the viewer's response to the question;
comparing the viewer's response with a correct response; and
if the viewer's response is substantially equivalent to the correct response, presenting the viewer with a reward.
